(19) United States
(12) Patent Application Publication
(10) Pub. No.: US 2002/0105398 A1
(43) Pub. Date: Aug. 8, 2002

(54) Circuit breaker trip bar with screw locating feature

(76) Inventors: Joseph Criniti, New Britain, CT (US); Javier Ignacio Larranaga, Bristol, CT (US)

Correspondence Address: Philmore H. Colburn II, Cantor Colburn LLP, 55 Griffin Road South, Bloomfield, CT, 06002, US

(21) Appl. No.: 09/779,211

(22) Filed: Feb. 8, 2001

(51) Int. Cl. H01H 9/00

(52) U.S. Cl. 335/172

(57) ABSTRACT

A trip bar assembly for actuating a latching mechanism to trip a circuit breaker is disclosed. In an exemplary embodiment of the invention, the trip bar assembly comprises a trip bar having an aperture and a calibration screw. The trip bar is configured to interact with the latching mechanism and the aperture has a predetermined length. The predetermined length of the calibration screw is less than said predetermined length of said aperture such that the calibration screw is encased within the aperture prior to calibration of the trip unit. The trip bar assembly increases the calibration yield of circuit breakers by locating the calibration screws during the calibrations process.

### BACKGROUND OF THE INVENTION

This invention relates to circuit breaker assemblies with a thermal magnetic trip unit and, more particularly, to circuit breakers with an adjustable thermal magnetic trip unit.

Circuit breakers typically provide protection against persistent overcurrent and against very high currents produced by short circuits. This type of protection is provided in many circuit breakers by a thermal-magnetic trip unit having a thermal trip portion, which trips the circuit breaker on persistent overcurrent conditions, and a magnetic trip portion, which trips the circuit breaker on short-circuit conditions.

In order to trip the circuit breaker, the thermal magnetic trip unit must activate an operating mechanism. Once activated, the operating mechanism separates a pair of main contacts to stop the flow of current in the protected circuit. Conventional trip units act directly upon the operating mechanism to activate the operating mechanism. In current thermal-magnetic trip unit designs, the thermal trip portion includes a bimetallic strip (bimetal), which bends at a predetermined temperature. The magnetic trip portion includes an anvil disposed about a current carrying strap and a lever disposed near the anvil, which is drawn towards the anvil when high, short-circuit currents pass through the current carrying strap.

Modern thermal trip units include a bimetallic strip (bimetal) that bends at a predetermined temperature. One end of the bimetal is attached, typically with a screw, to a strap that conducts current from the power source to the protected circuit. Another end of the bimetal is adjacent a trip bar. Upon the occurrence of an overcurrent condition, the bimetal bends towards the trip bar and contacts the trip bar which is mechanically linked to the operating mechanism causing the main current-carrying contacts to open and stop the flow of electrical current to a protected circuit.

It is necessary for such thermal trip units to be reliable. In addition, it is desirable that thermal trip units can be adjusted or calibrated so that the breaker can be adjusted to trip at different levels of overcurrent. Typically, after a circuit breaker is assembled, each pole of the breaker is then calibrated to trip at a predefined level by adjusting corresponding calibration screws. Calibration screws employed generally are longer in length than the aperture in which they are threadably engaged to ensure that the calibration screws can be assembled in the aperture. If the calibration screws are shorter in length, they can fall through inside the circuit breaker case. Further, a longer calibration screw can be difficult to locate in the assembled circuit breaker.

If the circuit breaker cannot be properly calibrated due to any inability to locate the calibration screw, the breaker must be disassembled and then reassembled. Disassembly and reassembly of the circuit breaker significantly decreases the calibration yield and increases production costs. Ease of pick up of the calibration screws is particularly important in a multi-pole circuit breaker since each pole's calibration screw must be aligned. The inability to calibrate any one calibration screw mandates the disassembly and reassembly of the circuit breaker. Thus, difficulty or failure to pick up the calibration screws will decrease first time calibration yield.

### BRIEF SUMMARY OF THE INVENTION

The above discussed and other drawbacks and deficiencies are overcome or alleviated by a trip bar assembly for actuating a latching mechanism to trip a circuit breaker. In an exemplary embodiment of the invention, the trip bar assembly comprises a trip bar having an aperture and a calibration screw. The trip bar is configured to interact with the latching mechanism and the aperture has a predetermined length. The predetermined length of the calibration screw is less than said predetermined length of said aperture such that the calibration screw is encased within the aperture prior to calibration of the trip unit.

### BRIEF DESCRIPTION OF THE DRAWINGS

Referring to the exemplary drawings wherein like elements are numbered alike in the several FIGS:

FIG. 1 is a perspective view of a circuit breaker;

FIG. 2 is an exploded view of the circuit breaker of FIG. 1;

FIG. 3 is a side view of the operating mechanism of the circuit breaker in FIG. 1;

FIG. 4 is a perspective view of the circuit breaker of FIG. 1 with the top over and mid cover removed;

FIG. 5 is a side view of an adjusting bar of the present invention;

FIG. 6 is a view of the adjusting bar of FIG. 5 taken along 1-1 prior to calibration; and

FIG. 7 is a view of adjusting bar of FIG. 5 taken along 1-1 after calibration.

### DETAILED DESCRIPTION OF THE INVENTION

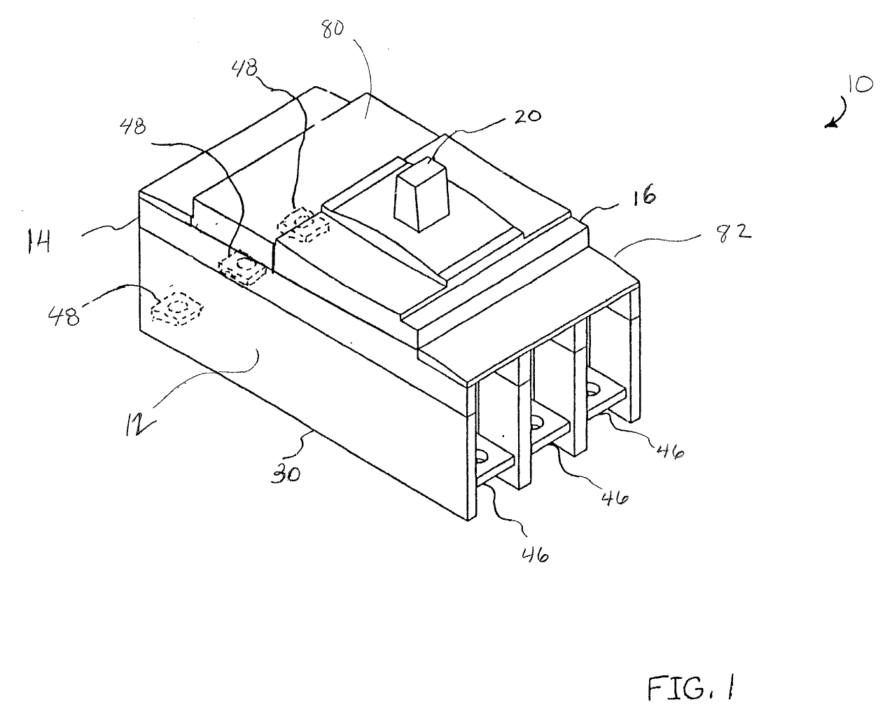

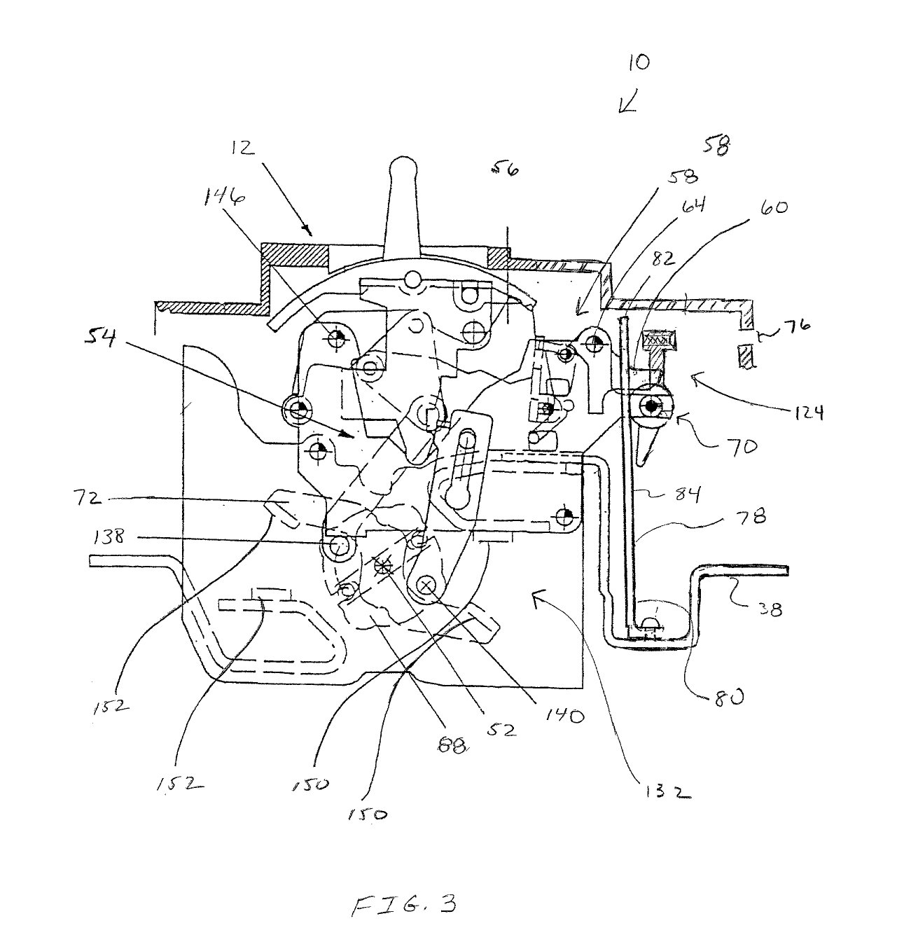

Referring to FIG. 1, an embodiment of a molded case circuit breaker 10 is generally shown. Circuit breakers of this type have an insulated case 12 and a mid-cover 14 that house the components of the circuit breaker 10. Mid cover 14 includes a first end 80 and a second end 82. A handle 20 extending through a cover 16 gives the operator the ability to turn the circuit breaker 10 “on” to energize a protected circuit (not shown), turn the circuit breaker “off” to disconnect the protected circuit (shown in FIG. 3), or “reset” the circuit breaker after a fault (not shown). A plurality of straps 46 and 48 also extend through the case 12 for connecting the circuit breaker 10 to the line and load conductors, respectively, of the protected circuit. The circuit breaker 10 shown in FIG. 1 shows a typical three phase configuration, however, the present invention is not limited to this configuration but may be applied to other configurations, such as one, two or four phase circuit breakers.

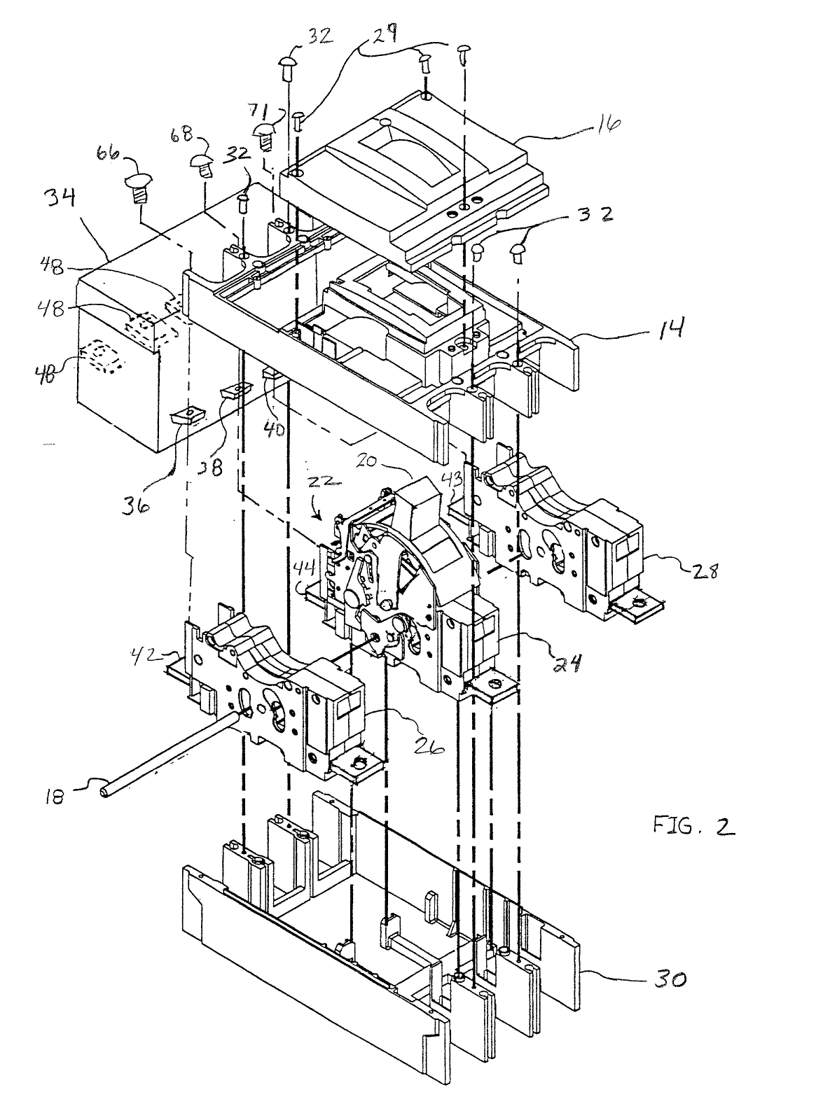

Referring to FIG. 2, the handle 20 is attached to a circuit breaker operating mechanism 22. The circuit breaker operating mechanism 22 is coupled with a center cassette 24 and is connected with outer cassettes 26, 28 by a drive pin 18. The cassettes 24, 26, 28 along with the circuit breaker operating mechanism 22 are assembled into the base 30 and retained therein by the mid-cover 14. The mid-cover 14 is connected to the base 30 by any convenient means, such as screws 32, snap-fit (not shown) or adhesive bonding (not shown). Cover 16 is attached to the mid-cover 14 by screws 29.

A thermal-magnetic trip unit 34 enclosed within case 12 having straps 36, 38, 40 preferably attaching to the cassette straps 42, 43, 44 with screws 66, 68, 69. Even though screws are shown herein for connecting the straps 36, 38, 40 to the cassette straps 42, 43, 44, other methods commonly used in circuit breaker manufacture are contemplated, such as brazing. The trip unit 34 is assembled into the base 30 along with the cassettes 24, 26, 28. Straps 36, 38, 40 conduct current from the power source to the protected circuit.

Referring to FIG. 3, circuit breaker 10 has a rotary contact arm 72 which is mounted on an axis 52 of a rotor 88 such that contact arm 72 can rotate. The rotor 88 itself is mounted in a cassette 24 (FIG. 2) and has two diametrically opposed satellite axes 138, 140, which are also rotated about the axis 52 when the rotor 88 rotates. The axis 138 is the point of engagement for a linkage 54 that is connected to a latch 56. The latch 56 is mounted, such that it can pivot, on an axis 146 positioned on the case 12. In the event of an overcurrent condition, latch 56 is released by a latching mechanism 58, moving the contact arm 72 to the OPEN position as shown in FIG. 3. In the OPEN position, a first and a second pair of electrical contacts 150, 152 are open thereby preventing current flow through the circuit breaker 10. The latching mechanism 58 can be actuated by a trip lever (trip cam) 60 that pivots about an axis of rotation 64.

Mounted to the circuit breaker 10 in the bottom region of the circuit breaker 10 and shown in FIG. 3 is the thermal portion of trip unit 34 (FIG. 2). Trip unit 34 includes a heat sensitive strip, for example, a bimetal 78, having a first end 80, a second end 82 and a surface 84 there between. The bimetal 78 is attached to strap 38 electrically connected to contact pair 150 of the circuit breaker 10. Any process commonly used in circuit breaker manufacturing can be used to effect the attachment of the bimetal 78 to the strap 38 including, but not limited to, mechanical fasteners, brazing, welding.

A calibration assembly generally shown at 124 is employed proximate the trip unit 34 and will be described hereinafter.

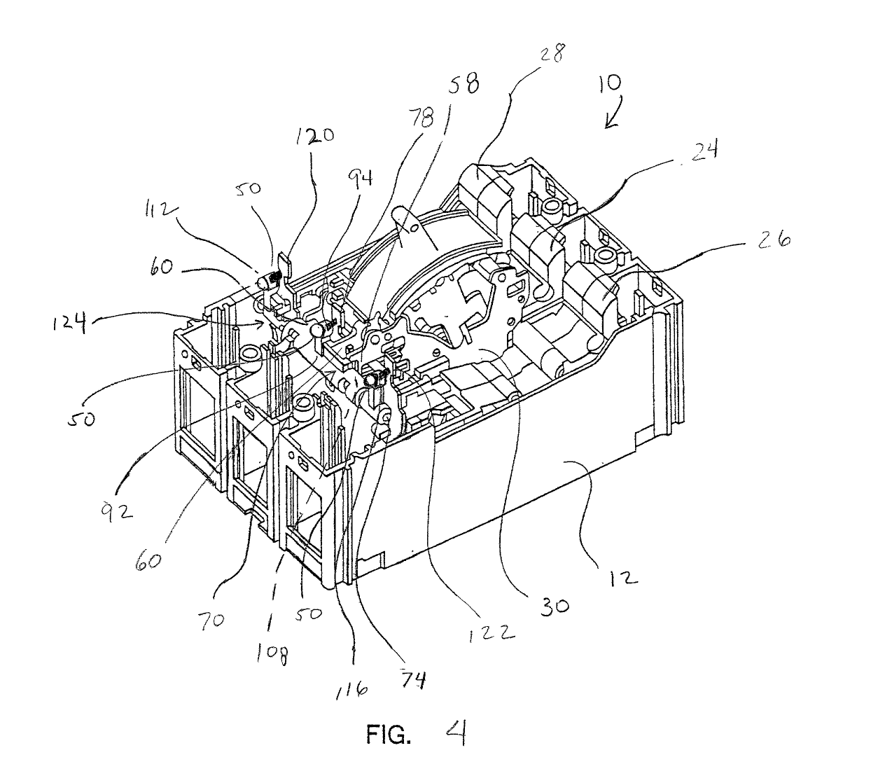

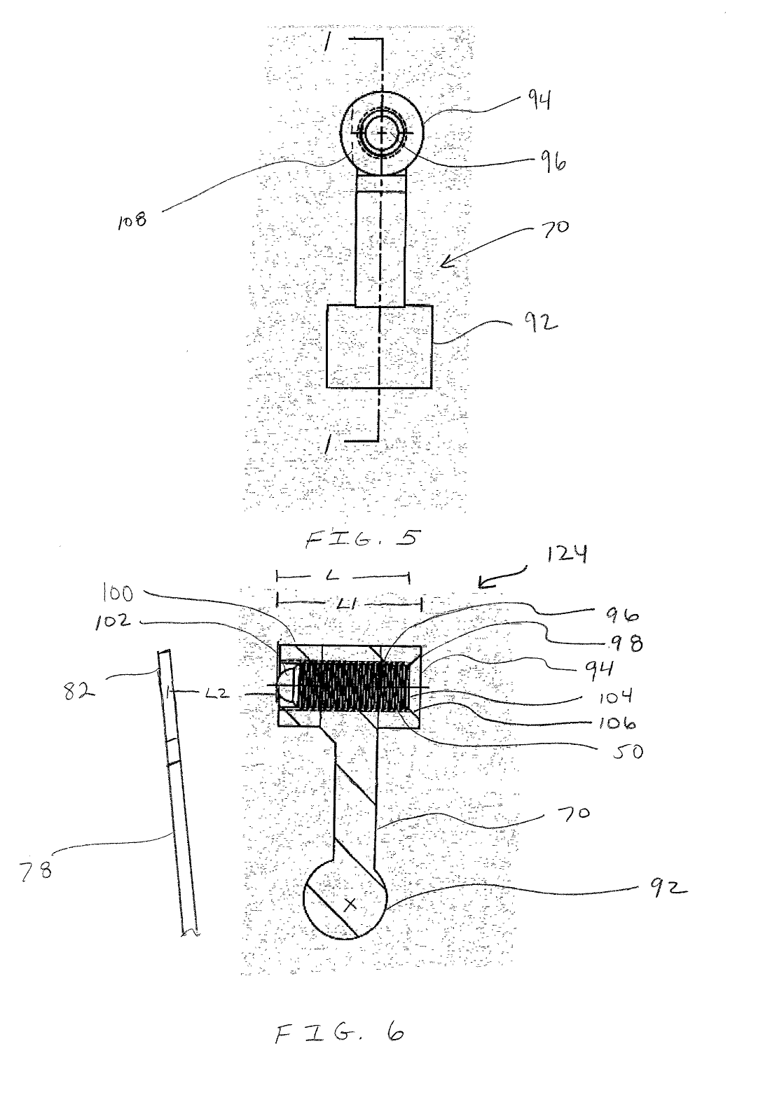

Referring to FIGS. 4, 5 and 6, the trip cam 60 contacts an adjusting bar (trip bar) 70, which is rotatably mounted about a trip shaft 74 supported by the latching mechanism 58. Adjusting bar 70 and a calibration screw 50 are part of the calibration assembly 124. FIG. 6 shows the calibration screw 50 preassembled with the adjusting bar 70.

Adjusting bar 70 is mechanically linked to the latching mechanism 58 through trip shaft 74. Adjusting bar 70 includes a main body portion 92, preferably cylindrical in shape that rotates clockwise about trip shaft 74. Trip shaft 74 extends longitudinally through the main body portion 92 of the adjusting bar 70. Extending from main body portion 92 is an arm 94 having a screw accepting aperture 96. Arm 94 includes an end 100 located proximate to the bimetal 78 and an opposing end 98. Main body portion 92 includes a cutout portion 108 extending partially through a midsection of main portion 92 that permits the adjusting bar 70 translational movement relative to the trip shaft 74.

Calibration screw 50 has a first end 102 and a second end 104. The second end 82 of bimetal 78 is aligned proximate with first end 102 of calibration screw 50. As shown in FIG. 6, calibration screw 50 is threadingly engaged in aperture 96 of arm 94. Calibration screw 50 is of a predetermined longitudinal length, L, such that the length L of the calibration screw 50 is less than or equal to a length L1 of arm 58. Length L1 extends from the end 98 to end 100 of arm 58. In this way, prior to calibration, the calibration screw 50 is fully encased within the aperture 96 of arm 94. Also, end 98 of arm 58 includes a chamfered inlet 106 having a predetermined inlet angle about the periphery of the inlet 106 to guide the calibration tool (e.g. screwdriver or other similar pick up device) to the second end 104 of the calibration screw 50.

Referring to FIGS. 3, 4, 6 and 7, the calibration of the trip unit 34 using the calibration assembly 124 is as follows.

First, as stated hereinabove, the calibration screw 50 is preassembled (FIG. 6) such that it is completely enclosed within arm 58 of the adjusting bar 70. Prior to calibration using the calibration tool, the first end 102 of the calibration screw 50 is positioned a predetermined distance L2 from the second end 82 of the bimetal 78.

Once the circuit breaker 10 is assembled with the mid cover 14 attached, the calibration process can begin. The calibration tool is inserted into an opening 76 (FIG. 3) located within the mid cover 14 and locates and engages the second end 104 of the calibration screw 50. The calibration tool will find the chamfered inlet 106 and go forward into the opening 76 to find the second end 104 of the calibration screw 50.

Once the second end 104 has been engaged by the calibration tool, the tool is employed to rotate the calibration screw 50 about its longitudinal axis in a first rotational direction threadingly engaging the calibration screw 50 within the threads of the aperture 96 in arm 58 of adjusting bar 70 thereby projecting the first end 102 of the calibration screw 50 outward from aperture 96 and in the general direction of the second end 82 of the bimetal 78. During the calibration, the calibration screw 50 is threadingly engaged into the aperture 96 so that first end 102 of the calibration screw 50 makes contact with the surface 84 of the bimetal 78 proximate the second end 82. Next, the tool is used to rotate the calibration screw 50 in a second rotational direction causing the first end 102 of calibration screw 50 to be retracted from engagement with the surface 84 of the bimetal 78. The final calibrated position of the calibration screw 50, after it is retracted, corresponds to a predetermined distance L3. In this way, the predetermined distance L3 is set using the calibration tool thereby setting the current at which the trip unit 34 (FIG. 3) responds to an overcurrent condition. In an unactuated state of the bimetal 78, which is to say when the contact arm 72 is closed and an overcurrent condition is not present, the predetermined distance between the first end 102 of the calibration screw 50 and the second end 82 of the bimetal 78 is L3.

When an overcurrent condition occurs, strap 38 generates heat that increases the temperature of the bimetal 78. If the temperature of the bimetal 78 increases sufficiently, due to the current draw exceeding a predefined current level, the second end 82 of the bimetal 78 deflects from an initial position thereby engaging first end 102 of the calibration screw 50. Due to the force applied by the bimetal 78 to the first end 102 of the calibration screw 50, adjusting bar 70 rotates in a clockwise direction rotating the trip lever 60. The rotation of the trip lever 60 unlatches the latching mechanism 58 such that it in turn can release latch 56 for a pivoting motion. This motion of latch 56 brings about a rotation of contact arm 72 disconnecting the contact pair 62 causing all poles of the circuit breaker 10 to trip in response to the overcurrent fault condition.

Predetermined distance L3 ensures that the first end 102 of the calibration screw 50 after final calibration is permitted engagement with the heated bimetal 78 as it deflects during a predetermined overcurrent condition.

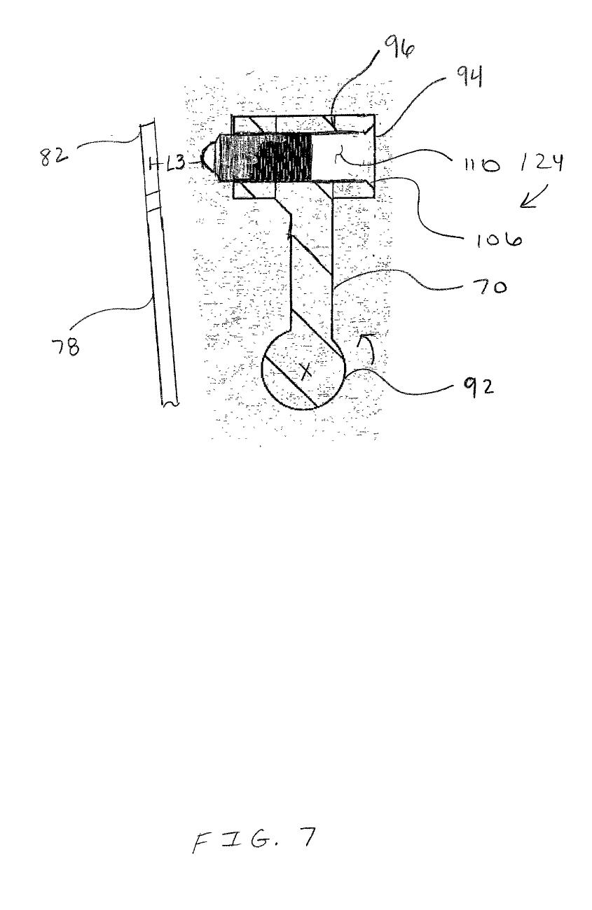

The calibration screw 50 is shown in FIG. 7 after calibration is complete. It is shown that the calibration screw 50 projects outward from the aperture 96 creating a pocket section 110 proximate to the end 98 of arm 58. At this point, the sealing of the calibration screw 50 using, for example, cements or adhesives, can be accomplished. The sealant is poured and localized within the pocket section 110 thereby avoiding excess spillage of the sealant inside the circuit breaker 10 where it is not desired and providing visual notification should the calibration screw 50 be tampered with after calibration has been completed by the manufacturer or end user. Preferably, the sealant is localized in the chamfered inlet 110 as well as in the pocket section 110 of the arm 58.

The present invention thus significantly increases the calibration yield of assembled circuit breakers. The adjusting bar 70 provides an arm 58 in which the entire length, L, of the calibration screw 50 can be captured within during assembly and prior to calibration. The calibration screw 50 is completely captured within the arm 58 of the adjusting bar 70 and is of a predetermined length, L, preferably less than that of the length, L1, of the arm 58. Further, the calibration assembly 124 and, in particular, the end 98 of the arm 58 of the adjusting bar 70 includes chamfered inlet 106. The chamfered inlet 106 guides the calibration tool to the location of the second end 104 of the calibration screw 50 so that the calibration process can take place. Successful contact by the calibration tool with the calibration screw 50 permits a high calibration yield for the circuit breaker 10. Another feature of the arm 58 is that after calibration is complete, the calibration screw 50 extends outward from the end 100 of arm 58 thereby creating the pocket section 110 of the arm 58 providing adequate space for localization of the sealant.

As shown in FIGS. 2 and 4, the adjusting bar 70 and the above described features of arm 58 including calibration screws 50 of the predetermined length, L, can be used in a multi-pole circuit breaker 10. In a multi-pole circuit breaker 10, the adjusting bar 70 includes multiple calibration screws 50, corresponding to the number of poles, and threadingly engaged in arms 58, 112, 116. It is further noted that arms 112, 116 are similarly configured as arm 58. Each calibration screw 50 for each pole is adjacent corresponding bimetals 78, 120, 122. For example, the multi-pole circuit breaker 10 of FIG. 1 is a rotary contact circuit breaker and includes a plurality of cassettes 24, 26, 28 (FIG. 2) with each cassette 24, 26, 28 having its own contact arm 72 and rotor assembly 132 as shown in FIG. 3 for cassette 24.

It is understood that one cassette is used for each phase in the electrical distribution circuit. Adjusting bar 70 extends along the row of cassettes 24, 26, 28, parallel to trip shaft 74.

Upon assembly as described hereinabove with reference to arm 58, the arms 58, 112, 116 capture each respective calibration screw 50 for all the poles of the circuit breaker 10 such that the calibration tool is readily guided to the second end 104 of each respective calibration screw 50. Thus, by capturing the calibration screw 50 within the adjusting bar 70, calibration screw pick-up is accomplished at the circuit breaker level as opposed to relying on the screwdriver or tool to ease calibration screw pick-up. Upon individual calibration of the tripping sensitivity for each pole, the calibration tool easily finds the calibration screws 50 as the features of the respective arms 58, 112, 116, as described hereinabove, guide the tool.

Thus, the arms 58, 112, 116 of the adjusting bar 70 significantly increase the calibration yield of multi-pole circuit breakers by decreasing the potential for misalignment of the calibration screws 50 during assembly of the circuit breaker 10. Decreasing the potential for misalignment ensures that the calibration process can be efficiently completed. Further, the pocket section 110 (FIG. 7) permits the localization of sealant avoiding sealant spillage onto undesirable areas of the circuit breaker.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A trip bar assembly for actuating a latching mechanism to trip a circuit breaker, the trip bar assembly comprising:
a trip bar having an aperture, said trip bar configured to interact with the latching mechanism, said aperture having a predetermined length; and
a calibration screw, said calibration screw having a predetermined length less than said predetermined length of said aperture;
wherein said calibration screw is encased within said aperture prior to calibration.

2. The trip bar assembly of claim 1 further including:
an electrically conductive strap; and
a bimetal electrically connected to said strap;
wherein said trip bar includes an arm extending therefrom, said arm having a first end and a second end, said aperture extending from said first end to said second end and said calibration screw adjusts a gap between said calibration screw and said bimetal and said bimetal strikes said calibration screw when said current transfer through said strap exceeds a predetermined value rotating said trip bar assembly to actuate the latching mechanism.

3. The trip bar assembly of claim 2 wherein said arm having a predetermined length extending from said first end to said second end and said arm encloses the calibration screw within said aperture.

4. The trip bar assembly of claim 3 wherein said bimetal having a first end and a second end, said first end of said bimetal electrically connected to said strap and said second end of said bimetal strikes said calibration screw when said current transfer through said strap exceeds a predetermined value rotating said trip bar assembly to actuate the latching mechanism.

5. A circuit breaker comprising:
a contact pair;
a latching mechanism configured to separate said contact pair; and
a trip bar assembly comprising:
a trip bar having an aperture, said trip bar configured to interact with said latching mechanism, said aperture having a predetermined length; and
a calibration screw, said calibration screw having a predetermined length less than said predetermined length of said aperture;
wherein said calibration screw is encased within said aperture prior to calibration.

6. The circuit breaker of claim 5 further including:
an electrically conductive strap; and
a bimetal electrically connected to said strap;
wherein said trip bar includes an arm extending therefrom, said arm having a first end and a second end, said aperture extending from said first end to said second end and said calibration screw adjusts a gap between said calibration screw and said bimetal and said bimetal strikes said calibration screw when said current transfer through said strap exceeds a predetermined value rotating said trip bar assembly to actuate said latching mechanism.

7. The circuit breaker of claim 6 wherein said arm having a predetermined length extending from said first end to said second end and said arm encloses the calibration screw within said aperture.

8. The circuit breaker of claim 7 wherein said bimetal having a first end and a second end, said first end of said bimetal electrically connected to said strap and said second end of said bimetal strikes said calibration screw when said current transfer through said strap exceeds a predetermined value rotating said trip bar assembly to actuate the latching mechanism.

9. The circuit breaker of claim 5 wherein said calibration screw includes a first end and a second end and having a predetermined length extending from said first end of said calibration screw to said second end of said calibration screw and said arm having a predetermined length extending from said first end of said arm to said second end of said arm;
wherein said predetermined length of said arm is at least equal to or greater than said predetermined length of said calibration screw.

10. A circuit breaker comprising:
a contact pair;
a latching means for separating said contact pair; and
a trip bar assembly comprising:
a trip bar having an aperture, said trip bar configured to interact with said latching mechanism, said aperture having a predetermined length; and
a calibration screw, said calibration screw having a predetermined length less than said predetermined length of said aperture;
wherein said calibration screw is encased within said aperture prior to calibration.

11. The circuit breaker of claim 10 further including:
an electrically conductive strap; and
a bimetal electrically connected to said strap;
wherein said trip bar includes an arm extending therefrom, said arm having a first end and a second end, said aperture extending from said first end to said second end and said calibration screw adjusts a gap between said calibration screw and said bimetal and said bimetal strikes said calibration screw when said current transfer through said strap exceeds a predetermined value rotating said trip bar assembly to actuate said latching means.

12. The circuit breaker of claim 11 wherein said arm having a predetermined length extending from said first end to said second end and said arm encloses the calibration screw within said aperture.

13. A method of calibration for a circuit breaker having a bimetal within a case for sensing current and a trip lever which causes actuation of a latching mechanism to interrupt current flow, the method comprising:
providing an adjusting bar having an arm including an aperture to receive and hold a calibration screw, said arm proximate to said bimetal;
encasing said calibration screw within said aperture such that said calibration screw is fully captured within said aperture;
positioning said calibration screw outward from said aperture and adjacent to the bimetal;
adjusting said calibration screw a predetermined distance from the bimetal; and
sealing an opposing end of said aperture.
